(19) United States
(12) Patent Application Publication
(10) Pub. No.: US 2010/0296365 A1
(43) Pub. Date: Nov. 25, 2010

(54) APPARATUS FOR TREATMENT OF LIQUIDS

(76) Inventors: Alexander BOLOBOLICHEV, Moscow Region (RU); Alexander BIRUIKOV, Stalevarov (RU)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(21) Appl. No.: 12/470,631

(22) Filed: May 22, 2009

(51) Int. Cl. B01F 7/00

(52) U.S. Cl. 366/292; 366/304

(57) ABSTRACT

An apparatus for treating a liquid is disclosed herein. The apparatus comprises a chamber defining an inlet and an outlet, a rotor located in the chamber; and at least one surface located in the chamber. The at least one surface is spaced apart and substantially parallel to the rotor. The rotor and the at least one surface define a reaction zone therebetween. The reaction zone is in fluid communication with the inlet and the outlet. The rotation of the rotor relative to the at least one surface is adapted to cause turbulence in the liquid passing through the reaction zone. At least one of the rotor and the at least one surface define a plurality of dimples thereon.

### FIELD

The described embodiments relate to an apparatus for treating liquids.

### SUMMARY

The embodiments described herein provide in one aspect, an apparatus for treating a liquid, the apparatus comprising:

a chamber defining an inlet and an outlet;

a rotor located in the chamber; and

at least one surface located in the chamber, the at least one surface being spaced apart and substantially parallel to the rotor;

wherein the rotor and the at least one surface define a reaction zone therebetween, wherein the reaction zone is in fluid communication with the inlet and the outlet;

wherein the rotation of the rotor relative to the at least one surface is adapted to cause turbulence in the liquid passing through the reaction zone; and

wherein at least one of the rotor and the at least one surface define a plurality of dimples thereon.

The embodiments described herein provide in another aspect, an apparatus for treating a liquid, the apparatus comprising:

a chamber defining an inlet and an outlet;

a rotor located in the chamber; and

at least one stator located in the chamber, the at least one stator being spaced apart and substantially parallel to the rotor;

wherein the rotor and the at least one stator define a reaction zone therebetween, wherein the reaction zone is in fluid communication with the inlet and the outlet;

wherein the rotation of the rotor relative to the at least one stator is adapted to cause turbulence in the liquid passing through the reaction zone; and

wherein at least one of the rotor and the at least one stator define a plurality of dimples thereon.

### DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a schematic diagram of a liquid treatment apparatus according to an embodiment of the present invention;

FIG. 2 is a plan view of the rotor and one of the stators of FIG. 1 according to an embodiment of the present invention;

FIGS. 3A and 3B are a series of partial cross-sectional views of one face of the rotor and the corresponding stator face of the apparatus of FIG. 1; and

FIG. 4 is a partial cross-sectional view of a liquid treatment apparatus according to another embodiment of the present invention.

### DESCRIPTION OF VARIOUS EMBODIMENTS

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

Described herein are various embodiments of an apparatus for treating liquids. In some embodiments, the apparatus is used to heat water for uses such as desalination and water treatment. In other embodiments, the apparatus is used to treat and refine hydrocarbon mixtures, such as crude oil (also referred to as “oil” for brevity).

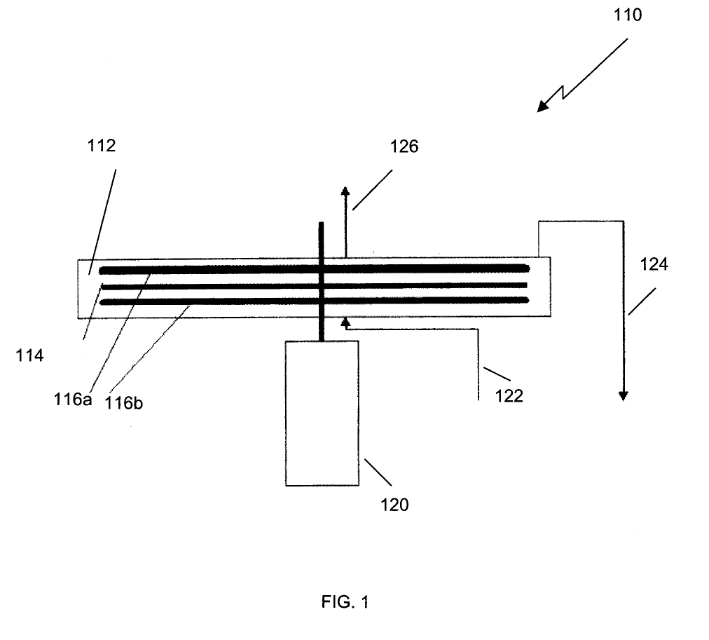

Reference is now made to FIG. 1, which schematically illustrates a liquid treatment apparatus 110 according to various embodiments. The liquid treatment apparatus 110 may be used in a variety of applications, including but not limited to refining oil and heating water. The liquid treatment apparatus 110 includes a chamber 112 having an inlet 122, a first outlet 124, and a second outlet 126. A rotor 114 and at least one surface, such as stator 116a, are located in the chamber 112. Preferably, two stators 116a, 116b are located in chamber 112, such that the rotor 114 is located between the stators 116a, 116b. A drive shaft 120, which projects out of chamber 112 is connected to the rotor 114.

In some embodiments, the rotor 114 and the stators 116a, 116b are disks of substantially equal sizes. Preferably, the disks are spaced apart from each other by a distance of 0.1 to 3 mm. In other embodiments, the disked are spaced apart by a distance outside of this range. It should be understood that, although a single rotor and two stators are illustrated, other configurations and a different number of disks could be used. For example, some embodiments may utilize configurations of a plurality of rotors and stators, such as for example but not limited to multiple stator-rotor-stator bundles, or one or more stator-rotor bundles. Some embodiments, include a plurality of rotors such as, for example, but not limited to, one or more rotor-rotor bundles or an odd number of rotors stacked together. These are examples only and are not intended to be limiting. Any appropriate configuration can be utilized.

Continuing to refer to FIG. 1, the drive shaft 120 rotates rotor 114 with respect to stators 116a,b. Preferably, the rotor rotates at a speed between 1000 and 10000 revolutions per minute. A liquid, such as crude oil feedstock, is introduced into chamber 112 through inlet 122. The liquid enters the space between the rotor 114 and stators 116a,b. As will be described in greater detail herein, the interaction of the disks creates a reaction zone in the liquid located in the space between the disks. The reaction zone, its conditions, and its effects, will be discussed in greater detail below. The conditions induced by the reaction zone causes the crude oil to be broken down into lighter fractions. More specifically, it cracks or separates the hydrocarbon fractions of the crude feedstock and thereby refines it into its lighter fractions. More specifically, the long hydrocarbon molecules, such as C₆₀-C₃₀-C₂₀, that are characteristic of heavy fractions, which may include tar, bitumen, and heavy gas oil are broken down into short hydrocarbon molecules, such as C₂₀-C₉-C₆, that are characteristic of light fractions, including but not limited to light gas oil, diesel, and gasoline.

The light fractions can be separated from any residual heavy fractions in any appropriate manner. For example, the products can be separated mechanically by weight. More specifically, the rotation of rotor 114 causes a centripetal force to be applied to the crude oil in chamber 112. The heavier fractions are pushed to the outer edges while the lighter fractions remain closer to the center. Consequently, the lighter fractions can be removed through the second outlet 126 and the heavier fractions can be removed through the first outlet 124. Optionally, the heavier fractions can be reintroduced through inlet 122.

In the case where the liquid introduced into chamber 112 is water, the conditions induced by the reaction zone cause the water to be heated. The rotation of rotor 114 causes a centripetal force to be applied to the water in chamber 112. The colder denser water is pushed to the outer extremities or the outer edges while the less dense hotter water collects towards the center of the motor 114. The colder water in chamber 112 is removed through first outlet 124. Optionally, this water can be reintroduced through inlet 122. The hotter water and water vapor produced in chamber 112 is removed through second outlet 126. In some embodiments, liquid treatment apparatus can heat a given mass of water to a given temperature using less energy than known water heating apparatuses for the equivalent amount of water.

Although, liquid treatment apparatus 110 can be used to treat a variety of liquids, the remaining description will focus on the treatment of crude oil feedstock. Various embodiments can be utilized for the treatment of a variety of liquids without modification. However, some embodiments used for treating different liquids may differ in the use of materials for various components, such as for example the rotors and stators, in order to take advantage of the various properties of these different materials.

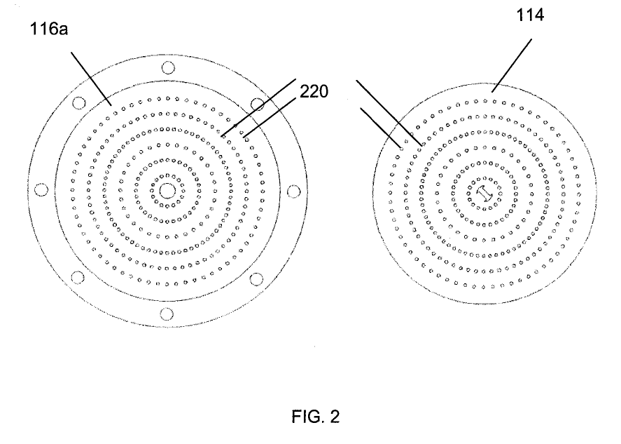

Reference is now made to FIG. 2, which illustrates a plan view of rotor 114 and stator 116a according to various embodiments. Preferably, the surface of stator 116b is substantially identical to stator 116a. Preferably, the rotor and stators are disks and the diameters of the disks are in the range of 100 to 600 mm. In other embodiments, disks with diameters outside of this range may be used.

A number of dimples 220 are formed on the two surfaces of the rotor 114 that face the stators 116a, 116b. Similarly, a number of dimples 220 are formed on the surfaces of each stator 116a,b that oppose the surfaces of the rotor 114. In some embodiments, the dimples have a hemispherical shape. In other embodiments, other suitable shapes may be used. In various other embodiments, holes extending all the way through the disks are used instead of indentations or dimples. Accordingly, as used herein, the term “dimple” can refer to an indentation or a hole. In some embodiments, the dimples 220 have a substantially circular shape on the surface of either the rotor or stator and have a diameter of between 0.1 to 3 mm. In addition, as will be explained in greater detail below, in different embodiments, the dimples can be of different shapes and sizes.

Rotor 114 preferably has a similar set of dimples on each of its faces. In some embodiments, the pattern of dimples 220 on the opposing faces of stators 116a,b and rotor 114 are complimentary to each other such that, as rotor 114 rotates with respect to the stators 116a,b, there are periods of time where at least some of the dimples 220 on the matching surfaces of the rotor 114 and stators 116a,b are aligned and periods of time where they are out of alignment. In some embodiments, this is achieved by having substantially the same pattern of dimples on each of the stators 116a,b and rotor 114.

In some embodiments, such as those illustrated in FIG. 2, the dimples are arranged in a pattern of concentric circles centered about the axis of rotation. In some embodiments, the concentric circles are separated by a distance of 1 to 5 mm. In some embodiments, adjacent dimples in a circle are separated by a distance of between 1 to 5 mm. It should be understood that these are examples only. Other embodiments may use different patterns and spacing for dimple positions.

The rotor 112 and stators 116a,b may be manufactured from any suitable material, such as various metals, alloys, or non-metallic substances. In various embodiment the discs may be comprised of materials such as titanium, nickel-cobalt alloys, flouroplastic. These are examples only and are not intended to be limiting. Other embodiments utilize other materials. As will be understood by those skilled in the art, different types of materials have different properties and may have different effects on different types of liquids. For example, in some embodiments, the discs are made of titanium. Titanium has hydrodynamic properties that may be advantageous. For example, titanium rotors and/or stators may assist in avoiding disc periphery fluctuation. Other embodiments may utilize a nickel-cobalt alloy. Nickel-cobalt's magnetic permeance can be advantageous. Some embodiments utilize flouroplastic, which is a dielectric. Flouroplastic's dielectric properties can be advantageous. In various embodiments, these various properties can be used to create electromagnetic fluctuations that can assist in breaking down molecular bonds.

In various embodiments, known catalysts can be added to the liquid prior to or after the liquid's introduction into chamber 112. These catalysts can be used to increase the efficiency of the treatment of the liquid. Thus, for example, in the case of refinement of crude oil, known catalysts can be added to the crude oil feedstock such that the catalysts function in a known manner to assist in the refinement of crude oil. In some embodiments, the rotor and stator disks may be coated with any appropriate catalysts including but not limited to platinum or palladium. In some embodiments, the entire disk is covered with the catalysts. In other embodiments, only the outer portions of the disks are covered by a catalyst. In some embodiments where a catalytic coating is used, only some of the disks are covered by a catalytic coating while others are not. In various embodiments, for reasons explained above, the heavier fractions tend towards the outer portions of the disks and therefore the outer portions of the disks are the more active portions. Accordingly, for reasons of economy, in some embodiments, only the outer portions are covered with the catalyst.

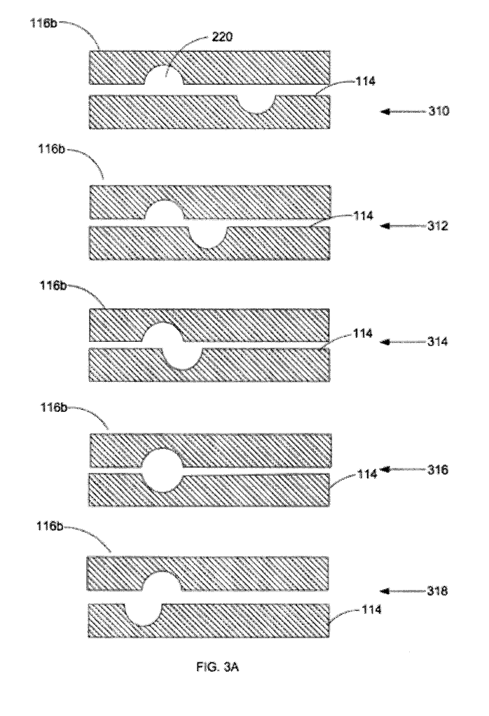

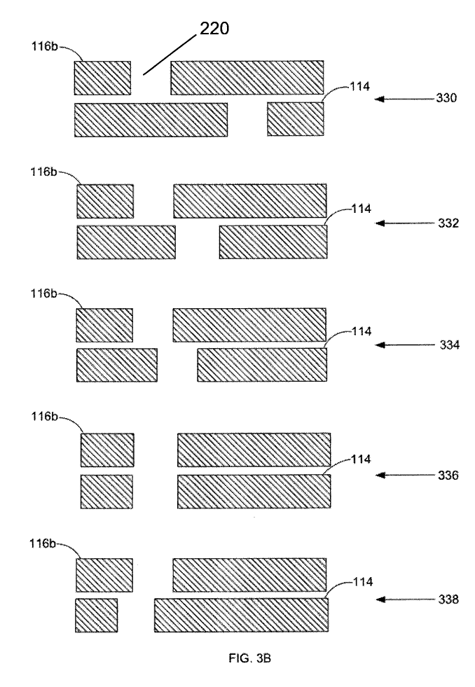

Reference is now made to FIG. 3A, which illustrates a series of partial cross-sectional views of one face of rotor 114 and the corresponding stator 116b for some embodiments where the disks comprise hemispherical dimples. More specifically, FIG. 3A illustrates various stages 310 to 316 of alignment of one dimple 220 on rotor 114 with one dimple 220 on stator 116b. As can be seen, states 310 to 314 show increasing states of alignment. State 316 shows the moment of alignment. State 318 illustrates the partial misalignment as the rotor continues to rotate with respect to the stator.

As mentioned above, although FIG. 3A illustrates hemispherical dimples, any appropriate shape of dimples can be used including, but not limited to, cylindrically shaped dimples. Moreover, as mentioned above, the dimples may be in the form of holes extending from one surface to the next of the disk. Reference is now made to FIG. 3B, which illustrates a series of partial cross-sectional views of one face of rotor 114 and the corresponding stator 116b for the case where the dimples 220 are holes. More specifically, FIG. 3B illustrates various stages 330 to 336 of alignment of one dimple 220 on rotor 114 with one dimple 220 on stator 116b. As can be seen, states 330 to 334 show increasing states of alignment. State 336 shows the moment of alignment. State 338 illustrates the partial misalignment as the rotor continues to rotate with respect to the stator.

The inventors have observed that the alignment of the dimples, which in some embodiments are holes, on opposing faces of the disk and the subsequent misalignment (as illustrated for example in FIGS. 3A and 3B) induce the conditions that characterize the reaction zone. The reaction zone forms in the liquid between the faces of the opposing surfaces of the stator 116a, 116b and rotor 114. In particular, the reaction zone is characterized by turbulence in the liquid. The inventors theorize that, in the reaction zone, bubbles are formed and subsequently implode. The implosion of the bubbles releases energy. The reaction zone is also characterized by high temperature and high pressure. In addition, as a result of the turbulence the liquid molecules move at a high velocity. The inventors theorize that the high rate of velocity of the liquid molecules can cause electrons to be stripped from the molecules in the liquid and form ions. The subsequent movement of these ions may cause electromagnetic fields to form. These various conditions in the reaction zone may cause molecules to be destroyed and broken down into smaller molecules. In addition, these conditions cause the liquid to be heated. Thus, these effects may break down the heavier fractions of crude oil into lighter fractions. Similarly, these effects may heat water.

The inventors have observed that if the rotor 114 is rotated at a particular speed the liquid is suspended between the surfaces of rotor 114 and stator 116 but does not contact either the surface of rotor 114 or stator 116. The speed of rotation at which this occurs can vary depending on the liquid present in chamber 112 and can depend on factors such as the viscosity of the liquid and the density of the liquid. When operating at this particular speed, the frictional forces on rotor 114 are reduced. Accordingly, in various embodiments, identifying this particular speed is desirable in that the energy required for rotating rotor 114 and thereby operating the apparatus 110 may be reduced. In addition, this particular speed can be easily identified by varying the speed of rotation and monitoring the force or energy required to rotate the rotor 114.

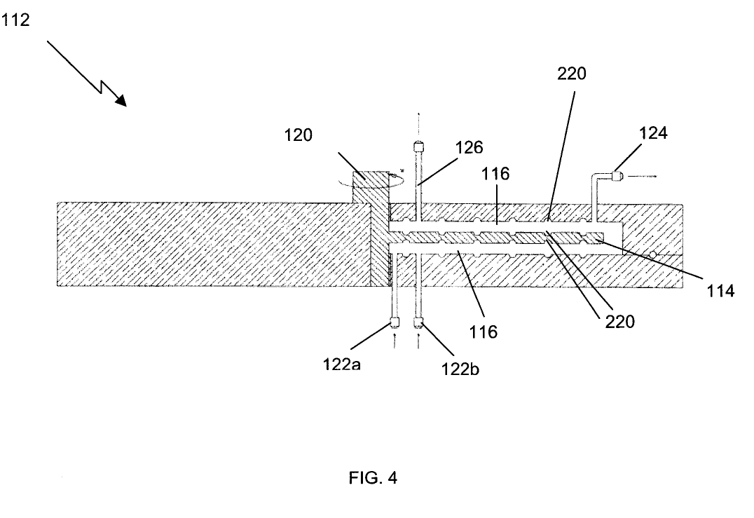

Reference is now made to FIG. 4, which illustrates a partial cross-sectional view of the chamber 112 according to an embodiment of the present invention. As can be seen, rotor 114 has a plurality of dimples 220 on each of its faces. One difference between the embodiments illustrated in FIG. 1 and FIG. 4 is that there are two inlets 122a, 122b illustrated in FIG. 4. In the embodiment illustrated in FIG. 4, the two inlets (122a and 122b) are included for the purpose of balance. However, a person skilled in the art will understand that other embodiments can utilize any appropriate number of inlets. More specifically, some embodiments, such as the one illustrated in FIG. 1, utilize one inlet; while, other embodiments utilize more than two inlets. Similarly, it will be understood that the embodiments described herein are not limited to two outlets and that any appropriate number of outlets can be utilized.

It should be understood that a liquid treatment apparatus according to an alternative embodiment of the present invention may be constructed as a stack of multiple chambers 112. In some embodiments, the apparatus according to an embodiment of the present invention comprises multiple modules where each module comprises a plurality of chambers 112 cascaded together. It should be noted that each of the chambers 112 in such an embodiment need not be identical. For example, the material used to construct rotors and stators that are used in the various chambers 112 can differ from one chamber 112 to another. A chamber 112 at one end of the stack is exposed to different substances than one at the other end given that the oil products become more refined as the feedstock moves through the various chambers 112. Thus, the rotors and/or stators may be manufactured from different materials to account for the different properties of the various hydrocarbon chains present in different parts of the module.

The various embodiments described herein do not require heating of the crude oil during the refinement process. Consequently, the refinement process according to the described embodiments can be more ecologically sound than traditional methods of refinement. In addition, various embodiments described herein do not require the consumption of water and there is limited waste treatment required. Furthermore, various embodiments require a smaller space as compared to traditional plants for equivalent processing capacity. In addition, for various embodiments the operational cost is low as compared to traditional plants of equivalent capacity. Specifically, in various embodiments the refinement process is not as labor intensive as are the methods of operating traditional plants. In addition, in various embodiments, the materials for various components are selected to be robust (such as the use of titanium for the disks) and therefore do not require frequent maintenance.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. An apparatus for treating a liquid, the apparatus comprising:
(a) a chamber defining an inlet and an outlet;
(b) a rotor located in the chamber; and
(c) at least one surface located in the chamber, the at least one surface being spaced apart and substantially parallel to the rotor,
wherein the rotor and the at least one surface define a reaction zone therebetween, wherein the reaction zone is in fluid communication with the inlet and the outlet;
wherein the rotation of the rotor relative to the at least one surface is adapted to cause turbulence in the liquid passing through the reaction zone; and
wherein at least one of the rotor and the at least one surface define a plurality of dimples thereon.

2. The apparatus of claim 1, wherein the plurality of dimples are defined in the rotor and the at least one surface.

3. The apparatus of claim 1, wherein the dimples have a diameter in a range of 0.1 to 3 mm.

4. The apparatus of claim 1, wherein the plurality of dimples are holes in at least one of the rotor and the at least one surface.

5. The apparatus of claim 2, wherein the plurality of dimples define a shape, wherein the shape of the plurality of the dimples on the rotor is substantially the same as the shape of the plurality of dimples on the at least one surface.

6. The apparatus of claim 2, wherein the plurality of dimples form a pattern, wherein the pattern on the rotor is complementary to a pattern formed by the plurality of dimples on the at least one surface.

7. The apparatus of claim 6, wherein the pattern formed by the plurality of dimples on the rotor is substantially the same as the pattern formed by the plurality of dimples on the at least one surface.

8. The apparatus of claim 7, wherein the pattern is a plurality of concentric circles about the axis of rotation.

9. The apparatus of claim 8, wherein the concentric circles are spaced by a distance in a range of 1 to 5 mm.

10. The apparatus of claim 8, wherein the dimples within a circle are spaced apart at a distance in a range of 1 to 5 mm.

11. The apparatus of claim 1, wherein the rotor and the at least one surface are separated by a distance between 0.1 and 3 mm.

12. The apparatus of claim 1, wherein the rotor and the at least one surface are disks.

13. The apparatus of claim 12, wherein the disks have a diameter of between 100 and 600 mm.

14. The apparatus of claim 1, wherein the at least one surface comprises a stator.

15. The apparatus of claim 14, wherein the at least one surface comprises a first stator and a second stator, where the rotor is located between the first stator and the second stator.

16. The apparatus of claim 1, wherein the at least one surface comprises a second rotor.

17. The apparatus of claim 1, wherein a portion of at least one of the rotor and the at least one surface is covered by a catalytic coating.

18. The apparatus of claim 1, wherein the reaction zone is spaced apart from the rotor and the at least one surface.

19. The apparatus of claim 1, wherein the liquid is water.

20. The apparatus of claim 1, wherein the liquid is crude oil.

21. The apparatus of claim 1, wherein the turbulence is sufficient to cause the breakdown of molecules of the liquid.

22. The apparatus of claim 1, further comprising a plurality of rotors and stators.

23. The apparatus of claim 1, further comprising a plurality of rotors.

24. An apparatus for treating a liquid, the apparatus comprising:
(a) a chamber defining an inlet and an outlet;
(b) a rotor located in the chamber; and
(c) at least one stator located in the chamber, the at least one stator being spaced apart and substantially parallel to the rotor;
wherein the rotor and the at least one stator define a reaction zone therebetween, wherein the reaction zone is in fluid communication with the inlet and the outlet;
wherein the rotation of the rotor relative to the at least one stator is adapted to cause turbulence in the liquid passing through the reaction zone; and
wherein at least one of the rotor and the at least one stator define a plurality of dimples thereon.
